(19) United States
(12) Patent Application Publication
(10) Pub. No.: US 2007/0107019 A1
(43) Pub. Date: May 10, 2007

(54) Methods and apparatuses for an integrated media device

(76) Inventors: Pasquale Romano, Los Gatos, CA (US); Brian L. Hinman, Los Gatos, CA (US); Brian Sugar, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/268,990

(22) Filed: Nov. 7, 2005

(51) Int. Cl. H04N 7/18

(52) U.S. Cl. 725/80; 725/68; 725/100; 725/135; 725/81

(57) ABSTRACT

Apparatuses and methods are described for a set top box. The set top box may include a satellite television reciever module, a broadband internet module, a digital video recorder, a storage medium, a first output port, and an integrated user interface. The satellite television receiver module receives satellite television broadcasts and converts the broadcast for display on a television. The broadband internet module converts content in a broadband signal for display on the television. The digital video recorder (DVR) allows a user to manipulate a digital stream of vidio programming from the satellite television broadcast. The integrated user interface displays on the television to allow a user to access an integrated content user experience by displaying icons that allow the user to select content from the satellite television broadcasts, the content in the broadband signal, and content from a first computer connected to the first network.

### TECHNICAL FIELD

Embodiments of the present invention pertain to the field of entertainment sources, and, more particularly, to an integrated content-rich user experience.

### BACKGROUND

Consumers can receive entertainment content as well as communications from a wide variety of sources. However, consumers lack the ability to have an integrated content user experience for all of the sources of information and entertainment.

### SUMMARY

The set top box may include a satellite television receiver module, a broadband Internet module, a digital video recorder, a storage medium, a first output port, and an integrated user interface. The satellite television receiver module receives satellite television broadcasts and converts the broadcast for display on a television. The broadband Internet module converts content in a broadband signal for display on the television. The digital video recorder (DVR) allows a user to manipulate a digital stream of video programming from the satellite television broadcast including the ability to pause live broadcast feeds. The storage medium stores files within the set top box such as digital photograph files as well as the television programs from the satellite television broadcast. The first output port couples to a first network that carries digital signals from the set top box. The integrated user interface displays on the television to allow a user to access an integrated content user experience by displaying icons that allow the user to select content from the satellite television broadcasts, the content in the broadband signal, and content from a first computer connected to the first network.

Other features and advantages of the present invention will be apparent from the accompanying drawings and the detailed description that follows.

### BRIEF DESCRIPTION OF THE DRAWINGS

Embodiments of the present invention are illustrated by way of example and are not intended to be limited by the figures of the accompanying drawings, in which:

FIG. 1 illustrates a logical diagram of an embodiment of a set top box system that integrates satellite television content, broadband content from the Internet, phone services, e-commerce, and a range of entertainment services from a local home network through one set-top box and a backend central management system to create an integrated content user experience;

FIG. 2 illustrates a logical diagram of an embodiment of a set top box; and

FIG. 3 illustrates a block diagram of an embodiment of the satellite television path;

FIG. 4a illustrates a logical diagram of another embodiment of the set top box;

FIG. 4b illustrates a block diagram of an embodiment of the three way communications that occur between the set top box, a third party website hosting multi-media content, and the central management system server;

FIG. 5 illustrates an embodiment of a screen shot of the main page of the user interface;

FIG. 6a illustrates an embodiment of a screen shot of the video options page of the user interface;

FIG. 6b illustrates an embodiment of a screen shot of the My Recordings page 616b of the user interface;

FIG. 6c illustrates an embodiment of a screen shot of the electronic programming guide of the user interface;

FIG. 7 illustrates an embodiment of a screen shot of the Record-a-program screen of the user interface;

FIG. 8 illustrates another embodiment of a screen shot of the main page of the user interface;

FIG. 9a illustrates an embodiment of a screen shot of the Television Menu screen of the user interface;

FIG. 9b illustrates an embodiment of a screen shot of the Search function for the Television Menu screen of the user interface;

FIG. 9c illustrates an embodiment of a screen shot of the electronic program guide for the Television Menu screen of the user interface;

FIG. 10a illustrates an embodiment of a screen shot of the Movies main menu of the user interface;

FIG. 10b illustrates an embodiment of a screen shot of the My Movies page of the user interface;

FIG. 11a illustrates an embodiment of a screen shot of the Music main menu of the user interface;

FIG. 11b illustrates an embodiment of a screen shot of the Music playlist page of the user interface;

FIG. 12a illustrates an embodiment of a screen shot of the Photos main menu of the user interface; and

FIG. 12b illustrates an embodiment of a screen shot of the photo rolls page of the user interface.

### DETAILED DESCRIPTION

In the following detailed description, numerous specific details are set forth in order to provide a thorough understanding of the invention. However, it will be understood by those skilled in the art that certain embodiments of the present invention may be practiced without these specific details. In other instances, well-known methods, procedures, components, and circuits have not been described in detail so as not to obscure the presented embodiments of the invention. The following detailed description includes several modules, which will be described below. These modules may be implemented by hardware components, such as logic, or may be embodied in machine-executable instructions, which may be used to cause a general-purpose or special-purpose processor programmed with the instructions to perform the operations described herein. Alternatively, the operations may be performed by a combination of hardware and software.

In general, apparatuses, systems, and methods are described for a set top box. The set top box may include a satellite television receiver module, a broadband Internet module, a digital video recorder, a storage medium, a first output port, a second output port, and an integrated user interface. The satellite television receiver module receives satellite television broadcasts and converts the broadcast for display on a television in formats such as a high definition format, a standard definition format, or similar format. The broadband Internet module converts content in a broadband signal for display on the television. The digital video recorder (DVR) allows a user to manipulate a digital stream of video programming from the satellite television broadcast including the ability to pause live broadcast feeds. The storage medium stores files within the set top box such as digital photograph files, digital music files, as well as the television programs from the satellite television broadcast and other similar electronic files. The first output port couples to a first network that carries analog video signals from the set top box. The second output port couples to a second network that carries digital signals from the set top box. The integrated user interface displays on the television to allow a user to access an integrated content user experience by displaying icons that allow the user to select content from the satellite television broadcasts, the content including digital photograph files and digital music in the broadband signal, and content from a first computer connected to the second network that carries digital signals.

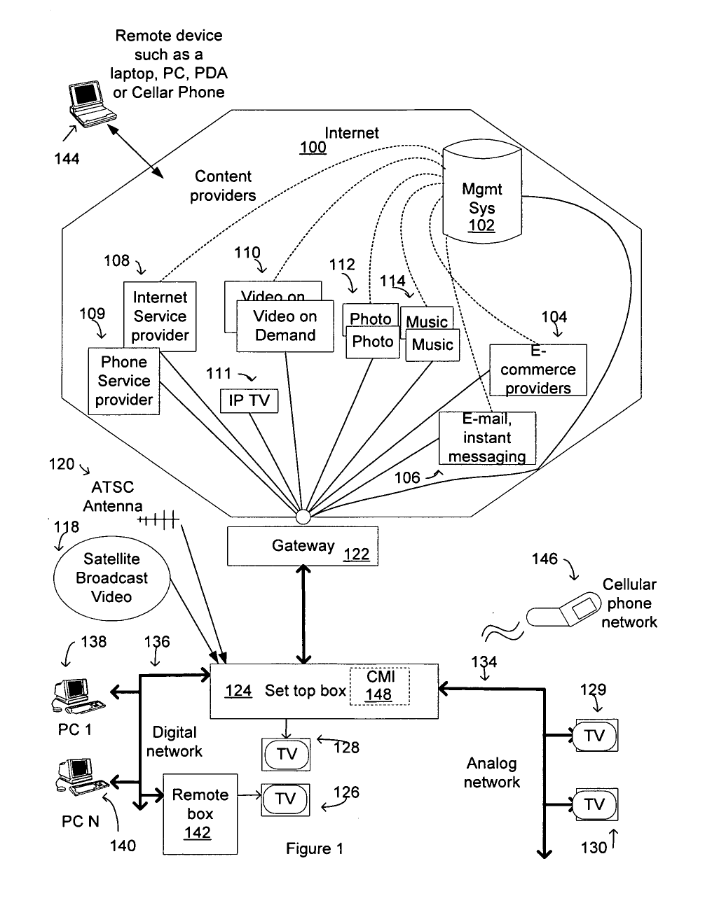

FIG. 1 illustrates a logical diagram of an embodiment of a set top box system that integrates satellite television content, broadband content from the Internet, phone services, e-commerce, and a range of entertainment services from a local home network through one set-top box and a backend central management system to create an integrated content user experience. The system 100 may include a central management system 102, e-commerce providers 104, e-mail and instant messaging services 106, an Internet service provider 108, content providers, such as Video on Demand (VoD) providers 110, digital photograph service providers 112, digital music service providers 114, Internet Protocol television providers 116, and other similar content providers, a satellite television provider 118, local TV and Radio antenna signals 120, one or more set top boxes 124, a gateway 122 to the local network, one or more televisions 126-132, a first network that carries analog signals 134, a second network that carries analog signals 136, one or more computing devices 138, 140, one or more client boxes 142, and one or more remote devices 144-146. The network gateway 122 such as cable modem, DSL Modem, or similar device may be internal or external to the set top box 124.

The set top box 124 may include various modules to receive content from these different sources of content and then convert the content to be properly rendered and displayed on a television 126-130. The various modules may be shown as logically distinct groupings of functions; however, the various modules may be integrated into a common module or have the functions of a single module broken out into two or more discrete modules. The set top box 124 may include a central management system interface 148. The central management system interface 148 communicates with a remote central management system 102 via a wide area network such as the Internet 150. The central management system 102 may receive communications from each set top box in the system, such as the first set top box 124. The software of the central management system 102 administers and integrates a three way billing exchange between a content provider 110-116, the central management system 102, and a set top box user's Internet service provider 108, such as a phone service or cable service provider. The software of the central management system 102 also performs catalog aggregation to present the set top box 124 with a common catalog presentation of available content based on type of content independent of the format provided by the source supplying that content.

The central management system 102 receives a request from the set top box 124 to view a catalog of available services and available content from a content provider selected by the user of the set top box 124 through the user interface of the set top box 124. The central management system 102 initiates a check, including parental controls and billing criteria, with the user's Internet service provider that the set top box 124 user is authorized to download that content. The content provider sends the catalog of available content and services provided by that content provider to the central management system 102. The software in the central management system 102 converts the catalog information provided by the content provide into a common display format for the user interface of the set top box 124. After verification from the Internet service provider 108, the central management system 102 transmits the catalog information provided by the content on the common display format to the set top box 124. Thus, the software of the central management system 102 performs catalog aggregation to present a common catalog presentation on the user interface of available content based on a type of content independent of the source of that type of content.

The user interface of the set top box 124 allows the user to select the desired content, such as a movie, song, photograph album, etc, from the catalog of that service provider. The central management system interface 148 of the set top box 124 communicates the selection from the user interface to the central management system 102. The central management system 102 transmits a secure voucher, such as a token, to the central management system interface 148 of the set top box 124 to purchase that content based on the verification received from the Internet service provider 108. The central management system interface 148 provides the secure voucher token to the content provider to allow the set top box 124 to download the selected content from the content provider. The central management system interface 148 of the set top box 124 communicates the downloading of the content to the central management system 102. The central management system interface 148 of the set top box 124 also communicates the actual viewing of the content.

After the actual viewing of the content, the central management system 102 communicates to the user's Internet service provider that the set top box 124 should be charged for the downloaded content. The user's Internet service provider 108, such as a phone/cable provider, integrates all of the charges from all of the content providers 110-116 onto a common bill associated with the user of that set top box 124.

The actual content, such as movies, photographs, music, etc, from the Internet content provider is exchanged directly (i.e. streamed) between the Internet content provider 110-116 and the set top box 124, via the gateway 122, while ancillary communications such as catalog listings and billing issues are communicated in a three way exchange between an Internet content provider, the central management system 102, and a user's Internet service provider 108. Low bandwidth communications concerning areas such as catalog information, billing issues, etc. are exchanged between each set top box 124 on the system and the central management system 102. The central management system 102 acts as the central piece to coordinate the billing and catalog information between the content providers, the phone service provider, etc. High bandwidth communications such as downloads of movies, music, photographs, etc. are exchanged between each set top box 124 on the system and the content providers.

The central management system 102 also keeps service delivery and customer management costs down by enabling the Internet service providers to diagnose or troubleshoot technical issues and provision customized data, voice and entertainment services remotely.

The set top box 124 has a broadband Internet module to convert the content in the broadband signal for display on a television 126-130. The set top box 124 may also send the content in the broadband signal to a first network that carries analog video signals and/or a second network that carries digital signals. The second network may include a multiple computers connected to that network as well as remote node boxes. In an embodiment, a broadband signal is a xDSL signal or other similar signal that has frequency ranges above the voice band such as 26 kHz to 1.5 MHz range and maximum transmission data rates of greater than 144 kilobits per second with typical ranges of maximum transmission data rates of greater than 1.5 Megabits per second.

The set top box 124 may also include a satellite television receiver module to receive satellite television broadcasts and convert the broadcast for display on a television 126-130 in either high definition format or standard definition format. The set top box 124 may also include a digital video recorder (DVR) to allow a user to manipulate a digital stream of video programming from the satellite television broadcast including the ability to pause display of a live broadcast feed. The set top box 124 may also include a storage medium that stores files within the set top box 124 such as digital photograph files, digital music files, downloaded content from the broadband content providers, as well as the television programs from the satellite television broadcast.

The set top box 124 may also include a digital media server to access the storage medium or a consumer device connecting to the set top box 124 to obtain the digital photograph files and the digital music files. The digital media server may also cooperate with a network module to obtain digital files such as digital photograph files from a computing device such as a first computer connected to the digital network.

The set top box 124 provides an integrated user interface displayed on a television 126-130 that allows a user to access an integrated content user experience by displaying icons to allow the user to select content from satellite television broadcasts, content including photographs and music from the Internet, and content from a local network including a first computer 138 and to have that content appropriately render on the user's audio device and video display device.

The set top box 124 has software to establish a secure connection for remote access. Through any Web-connected computer, such as a first lap top 144, customers will have the ability to remotely program their set-top box to record satellite entertainment, download movies on demand, and access their photos and personal music collection. Customers will also be able to remotely access files on computers connected to their home networks. Customers may be able to enjoy this remote access even by using a cellular wireless phone.

The set top box 124 system allows DSL subscribers to buy digital content or access streaming media services from the Internet via a set-top box. The set top box 124 system also makes digital content available to multiple devices over a home network. For instance, content can be delivered to and accessed from a home theater, second and third TV, stereo, PC or other networked appliance, or from outside the home using remote access.

A first output port of the set top box 224 couples to a first network 135 that carries digital signals from the set top box. The digital signals may be received by the remote box 142 and properly formatted to be displayed on a first high definition television 126. A second output port couples to a second network 136 that carries analog video signals from the set top box. The analog signals are properly formatted to be displayed on a second television 129.

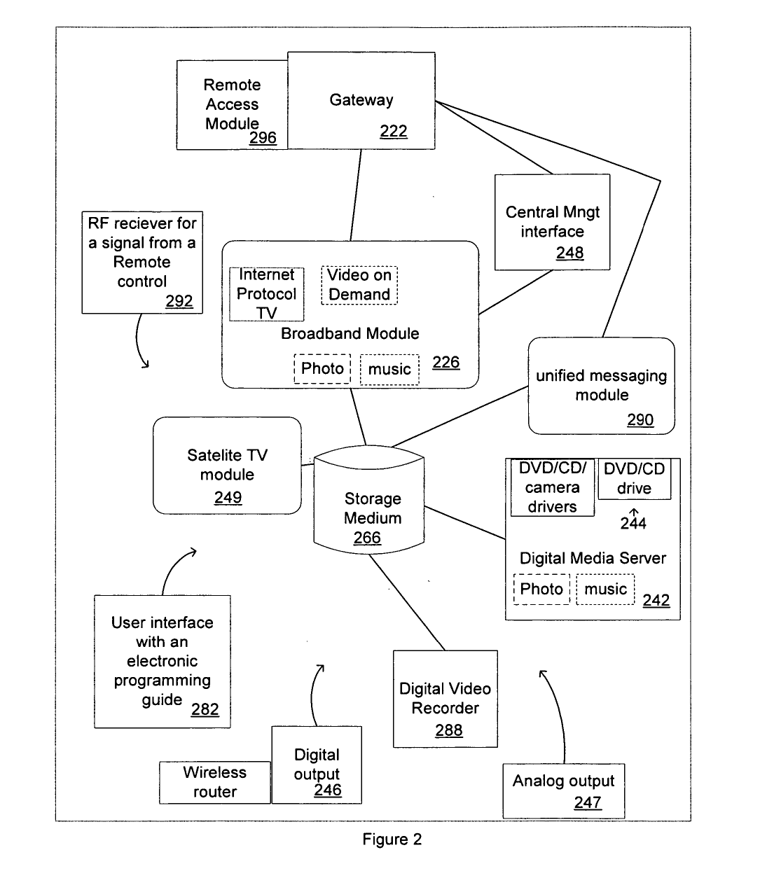

FIG. 2 illustrates a logical diagram of an embodiment of a set top box. The set top box 224 may include various modules such as satellite television receiver module 249, a digital video recorder (DVR) 288, a central management system interface 248, a broadband Internet module 226, a DVD/CD-ROM drive 244, a storage disk 266, such as a hard drive, a digital media server 242, and an integrated user interface 282, an analog network output module 247, and a digital network output module 246 including a wireless router, a unified messaging module 290, a Radio Frequency receiver module for the remote control 292, and other similar functional modules. Thus, the set top box 224 integrates content from broadband and satellite delivery networks with services from a range of Internet and satellite content partners, enabling providers to deliver to consumers home entertainment services such as media on demand, Personal Video Recorder (PVR), music and photo management, and unified messaging. The set top box 224 has a gateway 222 to convert the downstream broadband signal into a format usable by the set top box 224 and to transmit an upstream signal from the set top box 224 to the Internet. The format may be a variant of the digital subscriber line (DSL) format such as ADSL, VDSL, etc. In this diagram, the various logical blocks above are shown as separate parts for clarity, but they may be integrated as one or more units onto a main board.

As described above the central management system interface 248 communicates with a remote central management system. The central management system performs a number of functions such as administering and integrating a three way billing exchange between a content provider, the central management system, and a user's Internet service provider.

The set top box 224 may receive cable, DSL, and satellite services that include standard and premium video content, audio streams, and interactive services. The set top box 224 may render these signals for display on an analog television or a digital television.

The satellite television receiver module 249 receives satellite television broadcasts and converts the broadcast for display on a television in a format such as a high definition format, a standard definition format or a similar format. The software in the satellite television receiver module 249 supports different high definition (HD) and standard definition (SD) resolutions and signal formats.

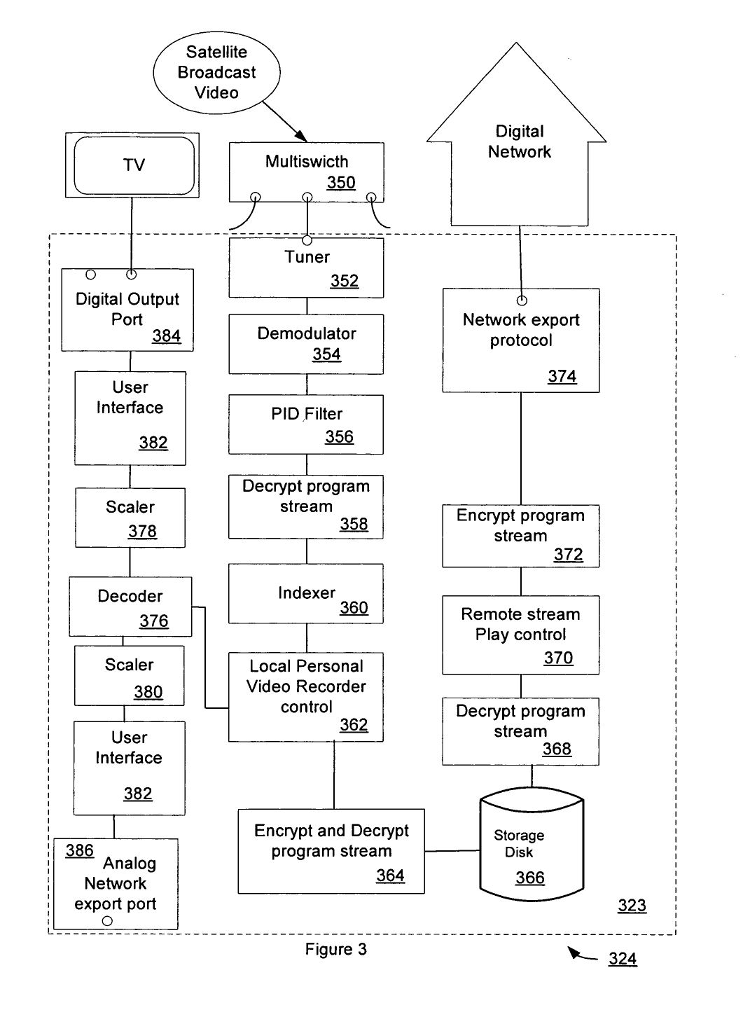

FIG. 3 illustrates a block diagram of an embodiment of the satellite television path. The example signal path for the satellite signal carrying television programming signals may include a multiswitch 350, one or more tuners 352, a demodulator 354, a PID filter 356, a decryption block 358, an indexer 360, a local personal video recorder block 362, a storage disk 366 encryption and decryption block 364 358, a storage disk 366, a remote decryption block 368 358, a remote stream play control block 370, a network encryption block 372, a network export module 374, a decoder block 376, a digital scaler block 378, an analog scaler block 380, a user interface block 382, a local digital output port 384 and a local analog output port 386. The satellite broadcast circuitry and software 323 work in concert to be capable of displaying two or more potentially different digital program streams containing video content on two or more televisions.

The satellite system may use a digital encoding scheme to broadcast the digital television programming signals over the air to the receiver at the user's home. The broadcast can use software, such as code in MPEG 2, to compress the size of the completely digital transmission. The broadcast can use software to encrypt the digital signal to prevent unauthorized use of the digital transmission as well.

The satellite dish at a user's home receives the wireless, compressed and encrypted, composite digital television programming video signal. A feed horn of the satellite dish may include a low noise block (LNB) and a multi-switch output 350. The LNB amplifies the radio signal bouncing off the dish and filters out the noise (radio signals not carrying programming). The LNB passes the amplified, filtered signal to the set top box 324 inside the viewer's house. The multiswitch 350 may supply a separate the received composite television programming video signal to each set top box 324 in the user's house.

The tuner 352 in the set top box 324, when tuned to particular channels, extracts the composite digital video signal and sound signal from the radio waves transmitted to the satellite dish. The tuner 352 may include one or more transponders. Each transponder outputs one or more transport streams. The tuner 352 may supply two or more different transport streams as output signals. In contrast to a conventional receiver that supplies out only one channel at a time that prevents a user from taping one live program and watching another live feed, the tuner 352 may output multiple channels. Thus, a user can, for example, watch two different programs on two TVs hooked up to the same set top box 324. In an embodiment, the tuner 352 consists of dual satellite tuners configured to receive high dentition (HD) and standard dentition (SD) signals and output signals for multiple discrete television channels. In an embodiment, the multiple tuner capacity of the tuner 352 coupled with the high-definition, high-capacity of the Digital Video Recorder allows a user to watch and record up to 3 programs simultaneously. The tuner 352 may be implemented through software, electronic circuits and or a combination of both.

The satellite composite television signal is broadcast in digital and the output of the tuner 352 may maintain the digital format for display on televisions capable of displaying digital television broadcasts. The demodulator 354 cooperates with the tuner 352 to separate each transport stream. Each transport stream carries multiple program streams. Each program stream corresponds to a particular channel such as a television channel. The PID filter 356 filters the digital program stream. The PID filter 356 may be tuned to filter out all signals except a particular program channel from the transport stream. Thus, the PID filter 356 outputs a program stream consisting of a single television channel. Each digital program stream is digital information encoded and compressed in a format such as MPEG-2. The set top box 324 does not separate or parse an incoming digital program stream into discrete audio and video components. A single digital file contains both the audio and video data.

The decrypt program stream block 358 descrambles the digital data based on the correct decryption algorithm and security keys. The broadcast encryption may scramble the digital data in such a way that it can only be decrypted (converted back into usable data) if the receiver has the correct decryption algorithm and security keys. The decrypt program stream block 358 de-scrambles the encrypted compressed digital signal. In order to unlock the signal, the set top box 324 may need the proper decoder chip for that programming package. The satellite provider can communicate with the chip, via the satellite signal, to make necessary adjustments to its decoding programs. The decrypt program stream block 358 may also be moved up the satellite signal reception path to decrypt each transport stream.

The indexer 360 indexes each of the frames of the digital video signal. The MPEG digital video stream carries both digital signals for the High Definition video and Dolby Digital audio signals. The indexer 360 may also extract from the transport stream or generate itself a services list. The services list may consist of a table having available television channels that can be crossed referenced to an associated transducer and satellite source. The modules in the set top box 324 to identify the transport stream carrying a particular television channel can then use the service list.

The received digital program stream may be uncompressed during the indexing of the video frames. In an embodiment, the digital program stream is maintained in the MPEG digital format. The MPEG digital format compresses the stream of video information by reusing data from one video frame over again in the next video frame. Also, in each image, the MPEG-2 software records just enough of the picture without making it look like something is missing. In subsequent frames, the software merely records changes to the image and leaves the rest of the image as-is from the previous frame. MPEG-2 reduces the amount of data by for, example, about 55 to 1. MPEG-2 Compression reduces image quality by throwing away image detail that the human eye ignores anyway. The MPEG encoder analyzes each frame and decides how to encode it. The encoder eliminates redundant or irrelevant data, and extrapolates information from other frames to reduce the overall size of the file. The output of the indexer 360 may be an uncompressed digital program stream with an index of each of the video frames. The Indexer 360 may directly access the storage disk 366 or may access the storage disk via the Personal Video Recorder control block 362.

The Digital Video Recorder includes the local Personal Video Recorder control block 362, the storage disk 366 such as a hard drive, and the remote stream play control block 370. The storage disk 366 is eventually coupled to an analog network and a digital network through network output cards and a variety of jacks on the back of the box. The DVR allows a user to pause live television or record television broadcast on the storage disk 366.

The encrypt and decrypt program stream block 362 encrypts the digital program stream when a television program is stored on the storage disk 366. The stored encoded signal is decrypted when being recalled by the local PVR 362 control block for transport on the analog network. The remote decryption program stream block 368 decrypts the stored digital program stream when a television program is being recalled by the remote stream play control block 370 for manipulation by the remote stream play control block 370. After the digital program stream is manipulated by the remote stream play control block 370, the network encrypt program stream block 372 then encrypts the digital signal again. The network export protocol block 374 couples to the digital network that carries digital signals to and from the set top box 324. The network export protocol block 374 act as an interface to properly format the digital signal onto the digital network so that television programming can be transmitted over the local digital network. The DVR operations will be described in more detail later.

In the analog output port 386 path from the set top box 324, the decoder 376 takes the digital MPEG-2 signal and converts the digital program stream into an analog format that a standard television 130 can recognize, such as such as National Television Standards Committee (NTSC) format; Phase Alternation by Line (PAL) format; and Systeme Couleur Avec Memoire (SECAM) format. The decoder 376 also has a digital signal output for a HD TV output. In the digital output port 384 path from the set top box 324, the decoder 376 may receive the digital program stream and use it, in digital form, to directly drive digital TV set coupled to the digital TV output port 384.

The digital scaler 378 may contain the software to support HD TV formats with resolutions such as 480p, 720p and 1080i resolutions. The digital scaler 378 may contain the software to support video formats such as WM9, MPEG-2 , MPEG-4, Real Video Dolby ®Digital 5.1. The digital scaler 378 may support both “interlaced” and “progressive” scanning systems. In an interlaced format, the screen shows every odd line at one scan of the screen, and then follows that up with the even lines in a second scan. Since there are 30 frames shown per second, the screen shows one half of the frame every sixtieth of a second. Progressive scanning shows the whole picture, every line in one showing, every sixtieth of a second. This provides for a much smoother picture, but uses slightly more bandwidth. The digital scaler 378 also may properly format shows to any number of aspect ratios (width to height) such as 4:3, 16:9, etc. The analog scaler 380 may contain the software to support various analog formats.

The user interface 382 may pick up a programming schedule signal from the satellite provider and present this information in an onscreen programming guide. The user interface 382 may check for parental lock-out options.

The DVR cooperates with the storage disk 366 to store television programs including live broadcast feeds. As discussed, the DVR includes personal video recorder software 362, which can cooperate with a scheduling engine to allow a user to perform manipulation of the digital programming stream. The personal video recorder software 362 contains scripts to 1) pause a live TV broadcast, 2) fast forward through frames of the digital programming stream, 3) reverse through frames of the digital programming stream, 4) skip back a preset amount of time, such as a thirty second increment, in the digital programming stream, 5) skip forward a preset amount of time in the digital programming stream, 6) perform slow-motion frame-by-frame display in both forward and reverse and 7) other manipulations of the digital programming stream.

The PVR software 362 may allow a user the option to pause live TV for up to two hours. The PVR 362 allocates a certain portion of the hard drive to being a live TV buffer. The PVR 362 freeze-frames the current image, giving the appearance of a paused videotape. When a user hits the play (un-pause) button on the remote, the PVR 362 causes the recorded program to begin playing. The hard drive is constantly recording, and generally keeps the preset amount of time such as a past two hours or so in the buffer. This means that if a user walks into the room ten minutes into a movie, the user can rewind by ten minutes and catch the beginning of the movie.

The personal video recorder software is also programmed to allow a viewer to start watching a program stored on the storage disk 366 in one room, pause the program with the remote, and then resume the playing movie from another room. The set top box may receive the radio frequency signal from a remote control in another room. In addition, a remote set top box may send the resume signal over the digital network to the remote stream play control block 370. The remote stream play control block 370 may call the stored movie file from the storage disk 366 in order for that movie to be transported over the digital network to another device in the user's house.

The remote stream play control block 370 controls the rate at which the digital program stream is being sent and received across the digital network. For example, the remote stream play control block 370 may compress the MPEG digital program stream for transport over the digital network by removing a video frame every couple of video frames from the digital program stream to give an appearance of a fast forward or a reverse operation while maintaining the same transmitted bandwidth over the digital network as during a play operation. For example, the remote stream play control block 370 removes every forth frame and sends the condensed video information at the same rate over the digital network to give the appearance of a fast forward or reverse operation. Likewise, the remote play stream control block 370 merely sends the base key video frames while removing, by not sending, every delta frame in between the base key video frames. Key frames contain all of the information required to display the frame, while delta frames require data from previously viewed key frames in order to be displayed. Delta frames in essence have the redundant data pixels from the key frame removed.

Alternatively, the remote stream play control block 370 may simply send the video frames at a reduce frame rate which lowers the total number of frames sent and gives an appearance of fast forwarding/rewinding through a video stream.

The DVR may contain a scheduling engine. The scheduling engine has scripts that cooperate with the user interface 382 to display a programming guide that allows the user to 1) record a live show while watching another live show, 2) record two live shows at once (either satellite or off-air), 3) record two live shows while watching another recorded show. 4) schedule to record shows in the future, 5) view and edit all of the user's currently scheduled recordings, 6) manage a user's library of recorded shows, 7) delete viewed shows to make room for others, 8) protect a user's favorite recordings from being deleted until that program is deselected. The scheduling engine may also include a series subscription script, which allows a user to tell the DVR to record every instance of a single program for an entire season, with the option of some advanced specifications. For instance, the user can select to always record the TV program “Frasier.” In addition, the user can select to merely record first-run episodes of the TV program “Frasier.” All of these functions are selectable through the use of a remote controller.

The user interface 382 may support an Electronic Program Guide (EPG) in the scheduling engine. The EPG gives a user instant access to what's currently playing on hundreds of channels as well as displays every scheduled program up to 14 days out. The EPG also allows a user to view a program's details (i.e. summary, actors and ratings) and search program listings by time, genre or keyword. With the Electronic Program Guide's Parental Controls feature and Content Screening service, a user can protect access to programs by their rating. The scheduling engine may decode a portion of the EPG from the downloaded satellite signal and then integrate content from the satellite EPG signal with other EPG information, such as VoD information and broadband information to generate the actual EPG supported by the user interface 382.

The user interface 382 may also present a DVR search tool screen that offers to help a user to find the programs the user wants to record. The DVR search tool screen searches to find programs with the query being key words such the name of program, the name of actors, and traditional keyword searches in the description of programs. The Web Remote Access service will let a user browse the TV program listings and schedule recordings from anywhere on the Internet.

The storage disk 366 may be a non-volatile memory capable to record and store, for example, 180 hours of Standard Definition programming, up to 25 hours of HD programming, or any combination on the non-volatile memory. The storage disk 366 may be made up of one or more hard drives, each with at least 250 gigabytes of storage capacity. The DVR can record programs at varying levels of quality. The DVR can record programs at least four different quality levels: basic, medium, high, or best. A 180-hour storage disk 366 can hold 180 hours at the basic quality level, but only about 25 hours at the best setting. Further, a program stored at a basic quality level may be stored as a highly compressed MPEG-1 file. A program stored at a medium quality level may be stored as a moderately compressed MPEG-2 file. The user interface allows a user to select these options.

The operating system of the set top box 324 may reside on the storage disk 366. The storage disk 366 may be partitioned for DVR recording space, a buffer for live broadcasts, and storage space for other media content.

Note, the use of MPEG-2 also permits a High Definition TV receiver in the television to interact with computer multimedia applications directly. CD-ROM applications can be properly rendered and played on HDTV display systems. The digital TV decodes the MPEG-2 signal and displays it just as a computer monitor does, giving it high resolution and stability.

The analog output port 386 couples to the network that carries analog video signals to and from the set top box 324. In the analog network, an analog signal carries intensity and color information for each scan line of the picture. The analog TV signal may have 525 scan lines for the image, and each image may be refreshed every 30th of a second (half of the scan lines are painted every sixtieth of a second in what is called an interlaced display). The digital information is converted to the analog format. In an embodiment, the set top box 324 may not insert index tags onto the frames of the analog video stream.

Also note, the tuner 352 may have software to support local off-air television programming in both high-definition (HD) and standard-definition (SD) formats. The Off-Air Tuner receives a local analog broadcast and supplies the signal to an encoder. The encoder may convert the analog signal to a digital signal in an MPEG format. The encoded signal may be stored on the storage disk 366.

Further, the tuner 352 may have software to support Internet Protocol TV (IPTV) programming in both HD and SD formats from content providers over the Internet.

Referring to FIG. 2, the set top box 224 may also contain a broadband Internet module 226. The broadband Internet module 226 converts content in the broadband signal for display on a television. The software of the broadband Internet module 226 may run a browser program with a number of plug-in modules to support content from different content providers. The broadband Internet module 226 also cooperates with the gateway 222 to form a DSL modem and Internet browser combination.

The broadband Internet module 226 contains plug in programs, such as media PC software, to legally purchase, download, display, and manipulate digital photograph files. The photo plug-in allows a user the ability to upload files and order prints of photographs from an Internet content provider. The plug-in allows a user to e-mail the digital photograph files to someone else. The plug-in allows a user to share all of the user's digital files with family and friends on their own personal website associated with the set top box 224. The user can view the downloaded and/or stored digital photograph files on the television. A user can perform all of this with a press of various buttons on the user's remote control.

The broadband Internet module 226 contains a plug in routine for legally purchasing, downloading, and playing digital music files on a sound system potentially connected to the television. The music plug in also is scripted to allow a user to listen to personalized streaming radio and watch the latest music videos on-demand. Thus, a user may download high-quality music from an Internet Radio station, such as Yahoo! Launchcast Internet Radio, via their DSL connection and listen to that music content on a home stereo, entertainment system, and/or networked PCs. The digital music files may be stored on the storage disk 266.

The broadband Internet module 226 includes a plug-in module configured to run Video on Demand content from a content provider on the Internet. The Video on Demand plug-in receives premium pay per view programming and converts the broadcast for display on a television in either high definition format or standard definition format. The Video on Demand plug-in is scripted to allow a user to browse through thousands of available television and movie titles by genre, title, actor or keyword search. The Video on Demand plug-in is scripted to allow a user to purchase and download movies securely and legally over the DSL connection from the user's television. The Personal Video Recorder allows the user to watch the pay per view programming with the same trick-play features as the DVR (i.e. 4-speed forward and reverse, slow motion, etc.). Alternatively, the software for the Video-on-Demand may be a multi-media application such as Windows Media™.

The broadband Internet module 226 may include a plug-in module configured to run Internet Protocol Television over the Internet fiber network.

The broadband Internet module 226 may include an electronic box office plug-in module configured to display the movies and show times showing at various movie theaters, view trailers of the movies, and purchase movie tickets from the user interface displayed on the television. The user may browse through current movie listings for show times and theaters, view trailers and purchase tickets displayed on the television using various buttons on their remote control.

The digital media server 242 has software scripted to deliver content around a user's home as well as to and from portable/handheld devices from a central access point. The digital media server 242 may access the storage disk 266, devices coupled to the digital network 246, content in the DVD/CD-ROM drive 226, or even consumer digital devices connecting to the set top box 224, via, for example, a Universal Service Bus port, to obtain the digital files within the consumer digital device, such as digital photograph files and the digital music files. The network module 246 couples to the digital media server 242 to allow a user to select a digital files from a first browser-enabled device located in room other than the room containing the set top box 224.

Software of the digital media server 242 may include a photo module programmed to automatically detect a portable camera device that connects to the set top box 224. The photo module loads the software driver for the camera device and automatically downloads any digital photograph files stored in the camera device into the storage disk 266. The software has a list of device drivers for portable digital camera devices as well as portable digital music devices that can be updated from the central management system. The software also has a list of default device drivers for the camera and music devices in case the specific device driver is not found.

Similarly, the software of the digital media server 242 may include a music module programmed to automatically detect a digital music device that connects to the set top box 224. The music module loads the software driver for the camera device and automatically downloads any digital photograph files stored in the music device into the storage disk 266.

The digital media server 242 may also obtain these digital files through a computer readable media placed in the built in DVD/CD-ROM drive 244.

The digital media server 242 allows a user to organize and store their personal digital media library on the internal storage disk 266 or any computer connected to the digital network. The digital network may be an Ethernet-based or peer to peer type network. The user interface 282 allows the user to browse and manage the user's digital music and photo collections. The remote controller may allow the user to select and interact with the user interface 282 displayed on the television. The user interface 282 allows the user to browse their music library by artist, album, title, genre or keyword search. The user interface 282 allows the user to create custom playlists of the user's favorite songs and edit them anytime. The digital music files may be encoded in a MP3 format using the built-in CD drive software. The user interface 282 allows the user to create named photo albums of favorite photos and add or remove pictures anytime. The user interface 282 allows the user to create virtual “rolls” for each upload session.

The built-in DVD/CD-ROM drive 244 lets the user play, read and burn DVDs and CDs so the user can easily add new digital files to their library or take the digital files for enjoying on the go. The media PC software lets the user listen to music and view the user's digital photos from any browser-enabled device in the home because the Set top box 224 is connected to the user's home network. The Media PC software is scripted to allow a user to access and share videos, music, and photos stored on any computer on the network with the set top box 224 and the client boxes. Further, the user may listen to music on a stereo or home theater connected to the television or connected directly to the jacks on the set top box 224

The photo module adds photos to a user's library by uploading them directly to a user's Set top box 224 from a user's digital camera, compact media card or CD disk.

The digital media server 242 may cooperate with the network export protocol module to allow the user to access all of their digital files such as digital photograph files and digital music files from virtually anywhere inside the home. The files may be physically stored on the internal hard drive 266, as well as any computer or storage device on the home network using the media PC software run on the digital media server 242. The media PC software allows the user to view the digital files from any browser-enabled device in the home through a Web interface. Thus, the digital media server 242 may cooperate with the broadband Internet module 226 to provide media management products to handle a user's existing collections of video and audio clips while also providing connections to streaming music and movie-on-demand services.

The set top box 224 includes various interfaces to support these various technologies. The audio visual interfaces may include HDMI, HD component video output, Composite video/stereo audio out (RCA), S-video out (4-pin mini-DIN), Coax RF out (F), and Optical digital audio out (Toslink). Additional interfaces may include Ethernet (RJ-45 10/100 Base-T), Wireless (802.11b/g Wi-Fi), and USB host ports (front and rear panel). The Set top box 224 has software that supports music formats such as MP3, AAC, WMA, and Real Audio. The Set top box 224 has software that supports photo formats such as JPEG, and PNG. The Set top box 224 has software that supports Security and DRM such as Windows Media 9 DRM, and Conditional Access System.

Referring to FIG. 1, the set top box 124 may distribute media content about the home using separate remote client box 142 in each room such as a MediaPoint set top box.

The remote client box 142 and the main set top box 124 exchange signals, via the remote stream control module, to allow a user to watch recorded shows, order video-on-demand, listen to music, view photos, and even pause live TV in one room and resume watching in another.

The set top box 124 employs digital content protection technology to distribution of premium content to the home and moves such content around the home. The premium content is protected throughout the entire digital distribution chain ensuring unencrypted digital content displayed on a television cannot be redistributed back out across the Internet. An encrypted digital signal of the premium content is transmitted across the digital network 135. An analog signal of the premium content is transmitted across the analog network 136. The analog video content distributed through the coax to other rooms is not digital and does not require digital content protection, which simplifies setup and lowers costs considerably.

The remote client box 142 may have the software to render and display the content supplied to it by the main set top box 124. The remote client box 142 may also have an integrated digital television receiver, a network-based digital video recorder, and a digital media client, and an analog television receiver. The remote client box 142 has similar software and hardware as the set top box 124 to support satellite and local off-air television programming in both high-definition (HD) and standard-definition (SD) formats. The remote client box 142 can also support Internet Protocol TV (IPTV) and be powered by the digital network 135.

The remote client box 142 and the main set top box 124 exchange signals, via the remote stream control module, to allow a user to watch recorded shows, order video-on-demand, listen to music, view photos, and even pause live TV in one room and resume watching in another.

Referring to FIG. 2, the set top box 224 may have a unified messaging module 290. The unified messaging module 290 is scripted to support communication applications such as e-mail, instant messaging, voice over IP, and video conferencing. The unified messaging module 290 brings all of these messaging applications and services into one convenient view that can be accessed on a user's television using a remote control. Further, The unified messaging module 290 cooperates with the Internet and phone service providers over the Internet. Local phone service customers will be able to view Caller ID and call-log information on their TV screen.

Through the user interface 282 cooperating with the unified messaging module 290, a user will experience integrated voice services through their television. The voice service displays of the user interface 282 may be menu-driven and allow the user to view and listen to all of the new and saved messages through the television. The on-screen caller ID announcements let the user see who's calling. The user interface 282 provides a “do not disturb” icon to block incoming phone calls when the user does not want to be interrupted. The unified messaging module 290 may combine wireline and wireless voice mail, e-mail and faxes into one mailbox.

The user interface 282 and the integrated keyboard on the remote control allow the user to compose e-mails, share photos with friends and family as e-mail attachments, instant message using instant messaging, etc.

As discussed, the set top box 224 integrates satellite TV programming, digital video recording, video on demand, and Internet content including Yahoo!® Photos, music, etc and home networked content. The user interface 282 of the set top box 224 integrates access and management these various types of content on a common user interface. The integrated user interface 282 displays on the television to allow a user to access an integrated content user experience by displaying icons that allow the user to select content from the satellite television broadcasts, the content including digital photograph files and digital music in the broadband signal, and content from a first computer connected to the second network that carries digital signals.

The upload feature of the user interface 282 allows a user to securely store and manage all of the digital content files from set top box 224 and the networked computers one convenient user interface 282. The user may add digital music files, and digital photograph files stored on computers throughout the home to the set top box's huge hard drive by browsing the storage location on the computer, selecting the desired files, and adding them to the digital media library on the hard drive by clicking on an upload icon. Similarly, these files may be transfer across the digital network to a computer hooked up to the digital network.

The share utility of the user interface 282 turns any PC on the network into a media server. The share utility of the user interface 282 supports the protocol to transfer the video, music and photo files distributed on computers throughout the home.

The user interface 282 may also display an Interactive TV guide, various TV features, search by show title, actor and description, select movies, view content on the Web, Jukebox listings of artist and songs, view photos, etc. A user interface 282 also includes a home screen to access all of the above-discussed applications.

A web enabled remote access module 296 establishes a secure link between a browser enabled device connected to the Internet and the set top box 224 via the central management system. The software in the web enabled remote access module 296 is configured to create a secure connection over a network. The web enabled remote access module 296 establishes the secure link in order to allow a user to access digital photograph files, digital music files, and to schedule their digital video recorder (DVR) remotely from any device connected to the internet, such as a Web-connected computer. The web enabled remote access module 296 presents a user interface to the user through a web page, such as SBC Yahoo! interface.

The remote access may be established by supplying the user credentials including password on a remote node. The server associated with the remote node where the remote device 144 connects to establishes a secure software tunnel to pass this information between the remote node and the server of the central management system 102. The server of the central management system 102 establishes a secure software tunnel between itself and the remote access module 296. The remote access module 296 verifies the credentials supplied by the user on the remote device 144 at the remote node. The remote access module 296 communicates whether a tunnel will be established with access authority to the applications on the set top box to the remote node via the server of the central management system 102. Thus, applications within the set top box may integrate themselves with software from a third party external to the box via verifying access credentials and creating a secure tunnel between the two applications.

The web enabled remote access module 296 securely extends a user's home network to anywhere on the Internet, allowing a user to enjoy, for example, their digital music files from the office, a friend's house or any broadband-enabled device. The web enabled remote access module 296 may support remote access through a wireless phone.

The web enabled remote access module 296 cooperates with the user interface 282 to request the user's network password and the user created URL address of the set top box 224. The user does not need to remember IP address numbers, just the user created URL address of the set top box 224. The central management system automatically manages the URL of the set top box 224 by using a dynamic domain name system (DDNS). The central management system 102 performs the network address translation between the actual IP address numbers and the user created URL address of the set top box 224.

The web enabled remote access module 296 ensures that access to the set top box 224 via the outside network is authenticated and encrypted between the remote Web browser and the Set top box 224. The connection from the remote browser to the gateway 222 may be secured using Secure Sockets Layer technology (SSL). Once connected, visitors may be directed to a special remote access Web page that displays links to available public files. In order to access private resources, the visitor must enter a pre-defined password.

The remote control has a full keyboard. The Radio Frequency remote control can be used in rooms external to the room containing the base set-top device to communicate with the base set-top device. Not only can the Ul and premium content be “remoted” to other rooms, but even DVDs playing back in the base Set top box 224 device can be remoted.

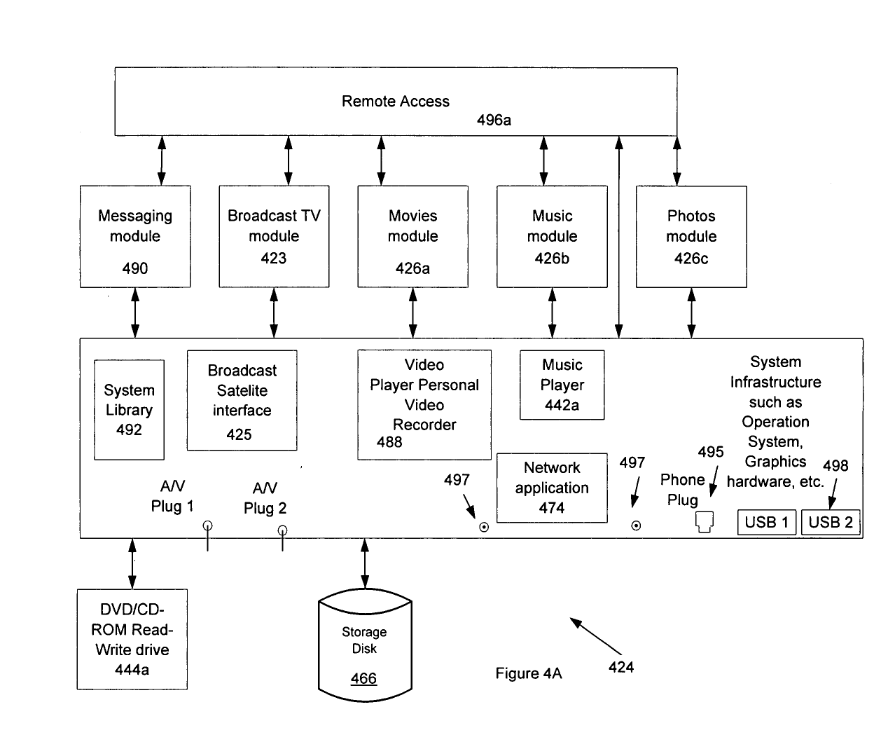

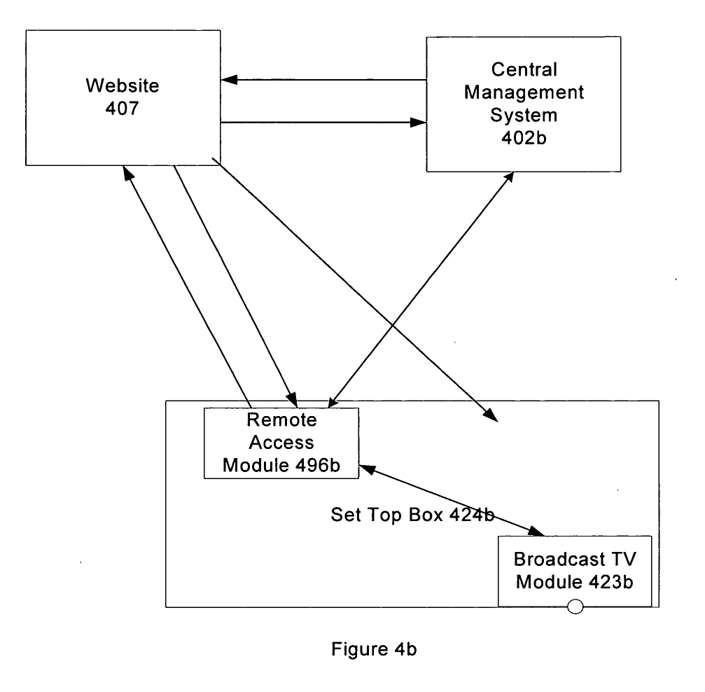

FIG. 4a illustrates another embodiment of a set top box configured to output two or more independent media data streams such as two different music streams, two different broadband content streams, two different video data streams including television programs and movies, etc. The media applications described below may operate and function similarly to their corresponding descriptions above. The differences in the implementation in this embodiment will be discussed below. The remote access module 496a may receive and send all broadband signals via the broadband plug connector 495. The satellite module will receive all satellite signals via the satellite dish signal path and then send those signals to the broadcast satellite interface 423. The network application 474 may receive and send network communications with other devices connected to the Local Area Networks (LAN) via the LAN connections.

Each media application such as a broadcast television application 423, a movie application 426a, a music application 426b, a photo application 426c, etc. may be scripted to be fully functional and operational on its own. The media applications may share a common library of routines 492 that contains utility scripts that the applications may place a function call to. For example, the music application 426b and the photo application 426c may both place a call to the same utility routine in the system library 492 to establish a connection between that application and content provided by a remote server. Overall, multiple media applications 426a-426c may be running resident on the operating system software of the set top box 424.

As discussed, each media application 426a-426c manipulates a single type of consumer media data such as music, movies, broadcast television, etc. Each media application 426a-426c has a complete set of files that have to be installed generally including executables, configuration files, and ancillary data files. Each media application 426a-426c may select content to be manipulated from at least four different independent sources of content. Some example independent sources of content may be 1) content locally stored in the storage disk 466, 2) content read via the DVD/CD-ROM read write drive 444a, 3) content from a portable device such as a digital camera or music player that connects via a USB port 498 of the set top box 424, 4) content stored on a computing device connected to the LAN, 5) content stored on a computing device connected to a wide area network and supplied over the Internet, and 6) content delivered via a satellite broadcast.

The data content stored on a computing device connected to the LAN is sent and retrieved by the media applications 426a-426c cooperating with the network application 474. The network application 474 also sends and retrieves data content via LAN connectors 497 to the digital network or the analog network. Additionally, the content stored on a computing device connected to a wide area network may be sent and retrieved by the media applications cooperating 426a-426c with the remote access application 496a and the gateway.

The content delivered via a satellite broadcast may be made available to the media applications 426a-426c via the broadcast satellite interface 425. For example, the movie module 426a may cooperate with the broadcast satellite interface 425 to display a Movie played from the a DVD/CD ROM read write drive 444a or retrieved over internet via the remote access application 496a.

The single set top box 424 may output two or more independent media data streams such as two different music streams, two different broadband content streams, two different video data streams including television programs and movies, etc. The single set top box 424 may output two or more independent media data streams by several methods such as instantiating each application program twice or scripting the application programs to be capable of executing multi-threaded instructions.

The video player of the digital video recorder (DVR) 488 allows the user to manipulate the program data streams coming from the broadcast television application 423 and the movie application 426a.

In an embodiment, the set top box 424 may use a digital image to install the software run on the set top box. A digital image is usually a file in a compressed file format that contains an exact replica of the applications, operating system, and configuration settings of a fully operational source computerized device at the time when the digital image was created. Thus, each subscriber's set top box may download a new digital image from a satellite broadcast based on certain criteria being detected. The criteria may be, for example, does the digital image corresponding to the ID associated with this set top box have a version number later in time than the version number of the digital image currently being implemented by this set top box. Each different group of set top box may download its own corresponding digital image. If the digital image broadcast by the satellite is a newer version of the currently installed digital image, then the program code in the set top box 424 may download and store the compressed digital image in flash memory. The program code in the set top box 424 may then un-compress the image and re-boot using the new digital image.

FIG. 4b illustrates a block diagram of an embodiment of the three way communications that occur between the set top box, a third party website hosting multi-media content, and the central management system server. Initially, the browser portion of the remote access module 496b connects with the property page of the third party website 407. The third party website 407 then retrieves identification and routing information about the set top box 424b from the initial request of the remote access module 496b. The website 407 first communicates with the central management system server 402b to obtain validation that the set top box 424b is able to purchase services from that website 407 and a redirect universal resource locator (URL) address instruction to the URL address of the specific set top box initiating the request. For example, the website 407 may send an Application Program Interface request that consists of an HTTP GET instruction to the central management system server 402b. The central management system server 402b may validate the signature using its shared secret. The central management system server 402b returns the URL address-redirect instruction that points to the remote access module 496b of the set top box 424b with a URL address that contains a signature that will be recognized by the set top box 424b.

Next, the website's server queries the set top box 424b using the redirected URL address. The web site may send a catalog of available media content to download/purchase. The set top box 424b validates the signature and returns the Application Program Interface call result. The website 407 formats and embeds the result on a web page. The remote access module 496b sends to the website 706 a list of selections from the catalog of available media content to download/purchase. The web site sends the selected list of content to the central management system server 402b for validation that it is okay to download this content and for authorization to download this content. The central management system server 402b sends the authorization token to the set top box 424b. The central management system server 402b also sends to the website 407 a redirect to the URL address of the set top box 424b. The central management system server 402b then records any billing data against the set top box's account. The remote access module 496b sends the token to the website 407. The website 706 downloads the content to set top box 424b. The remote access module 496b then communicates a confirmation that the set top box 424b received the selected content to the central management system server 402b.

Accordingly, in an embodiment, the remote access module 496b may have a number of application program interfaces that can be the primary means of remotely interacting with the set top box 424b. These interfaces scripted in the remote access module 496b set top box 424b allow for limited web based remote media browsing and management. As discussed above, the interfaces in the remote access module 496b may contain code scripted to integrate with the third party website, such as a movie vendor, to retrieve or send content from/to that website 407 or allow that website to stream video directly to the set top box 424b. The interfaces allow the remote access module 496b to support uploading and downloading of digital photos, uploading and downloading of digital music, downloading of movies, TV schedule browsing and manipulation, as well as other similar media browsing.

The remote access module 496b may have a number of example interfaces to facilitate transactions between the set top box 424b and the third party web site. For example, a data feed catalog interface is scripted into the remote access module 496b to allow users to get information about downloadable media content such as movie catalogs and song catalogs. An authorization interface scripted into the remote access module 496b allows users to download a token after the central management system communicates authorization to the third party web site 407. The authorization interface allows a way to authorize a fulfillment request and to download license tokens. A license retrieval interface is scripted into the remote access module 496b to allow users to retrieve the license file for the selected movie and/or songs. A download routing interface is scripted into the remote access module 496b to allow users to retrieve the media content file, via download or live streaming. The broadcast TV module 423b of the set top box 424b then cooperates with the remote access module 496b to properly display that content on a television or play that content through a sound system connected to the set top box 424b.

The remote access module 496bs integrates with the third party websites via 1) the scripted interfaces and 2) a client specific security mechanism, such as a shared secret, potentially based on the ID associated with that set top box 424b. Thus, the establishment of a secure connection between the devices relies on a shared secret. One shared secret exists between the web site and the central management system server 402b. Another shared secret exists between the central management system server 402b and each set top box. This shared secret is individual to each set top box. The verification of the shared secret has a specific time to live expiration time associated with the message establishing the security connection.

An alternative example implementation may be that the browser portion of the remote access module 496b still connects with the property page of the website 407. However, the website's server then returns a flash or JavaScript enabled page that contains pointers to invoke functions on the remote access module 496b. The Flash or JavaScript invokes an API by first going to the web site server to obtain a signed URL. The website 407 server signs the request. The Flash or JavaScript invokes the API call by going to central management system server 402b. The central management system server 402b validates the signature via the shared secret, reformats the URL and signs it. The HTTP engine follows a URL address redirect instruction to the URL of the set top box 424b. The set top box 424b returns an API result in XML format to the Web site.

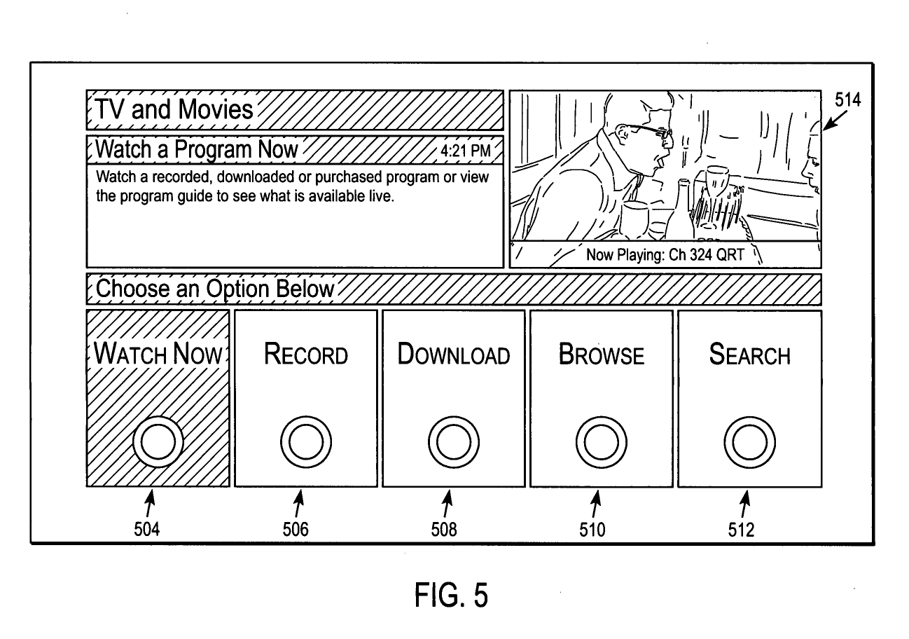

FIG. 5 illustrates an embodiment of a screen shot of the main page of the user interface. The main page 502 allows a user to select various options that activate the code for the corresponding module and/or media application in the set top box. The user may select from a Watch-a-program-now icon 504, a Record icon 506, a Download icon 508, a Browse icon 510, a Search icon 512, as well as other icons. The Download icon 508 allows the user to download from a networked device or a local drive. The Browse icon 512 allows a user to browse content stored on a networked device, content stored on the local hard drive, or content stored on the Internet. The user interface also contains code scripted to continue to display a video stream being played, such as a satellite television program or movie stored on the hard drive, in a picture window 514 while the user browses and progresses through selections on the user interface.

The primary navigation choices for a user browsing through the graphic user interface may be aligned in a horizontal orientation. The menu choices allow a user to watch something on now, record something to watch later, or download something to watch later. Note, the user interface may have many example configured pages but is not limited to the example configured pages as described herein.

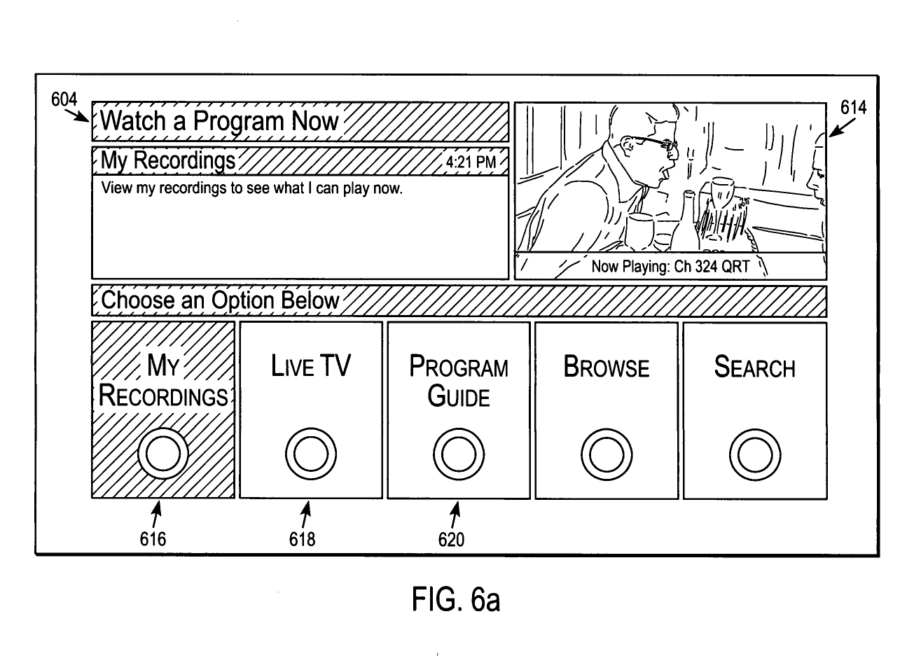

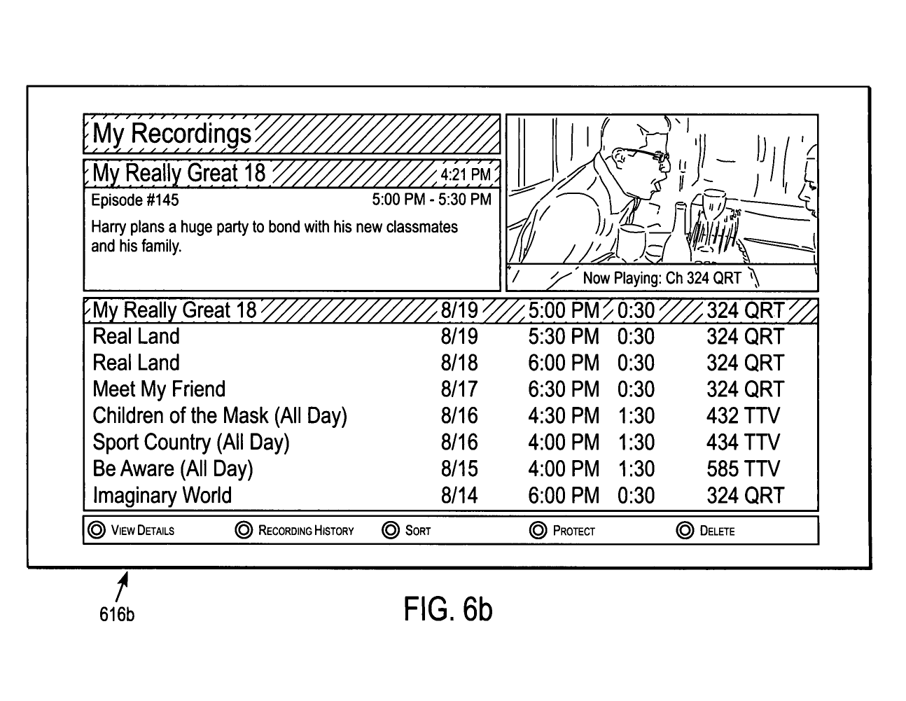

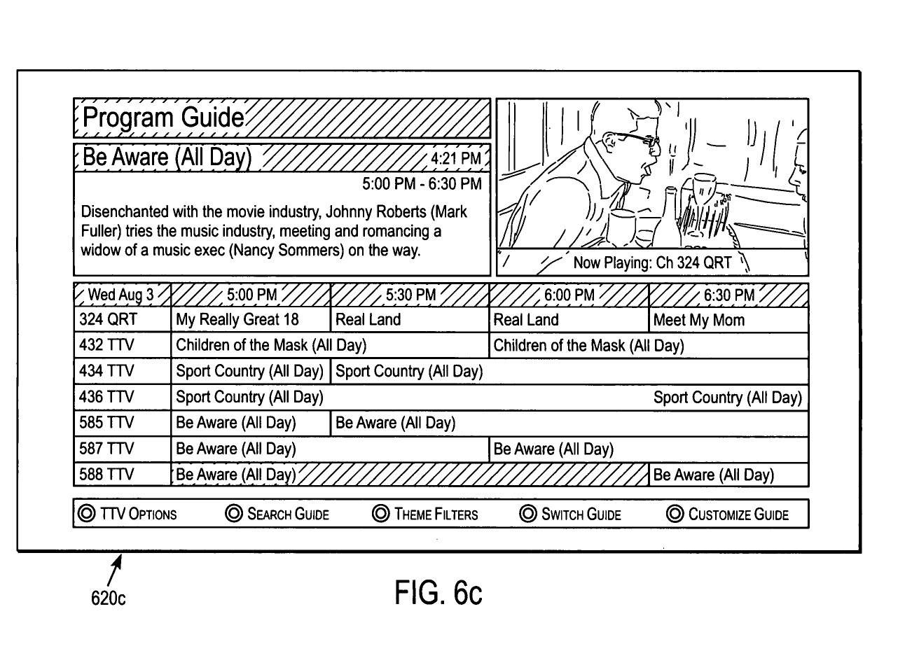

FIG. 6a illustrates an embodiment of a screen shot of the video options page of the user interface. Activation of the Watch-a-program now icon 504 allows the user to access the Watch-a-program screen 604. The Watch-a-program screen 604 allows a user to select video content to view. The video content may be selected from actuation of the My Recording icon 616. FIG. 6b illustrates an embodiment of a screen shot of the My Recordings page 616b of the user interface. Activation of the My Recording icon 616 allows the user to retrieve video content stored on the hard drive of the set top box. Also, the screen displays the title of the video content as well as additional meta data about the items listed in the active menu. Activation of the Live TV icon 618 allows the user to retrieve video content coming from the satellite video stream. Activation of the Program Guide icon 620 allows the user to retrieve an electronic programming guide 620c (see FIG. 6c). FIG. 6c illustrates an embodiment of a screen shot of the electronic programming guide of the user interface.

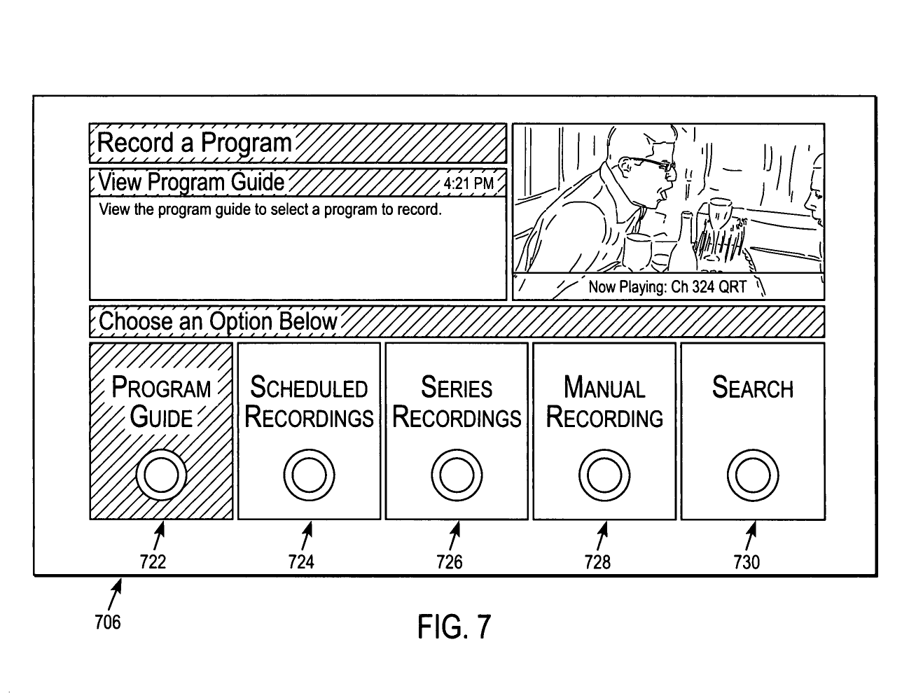

FIG. 7 illustrates an embodiment of a screen shot of the Record-a-program screen of the user interface. Activation of the Record icon 506 allows the user to access the Record-a-program screen 706. The user may record a program from the program guide 722, program/view scheduled recordings 724, record an entire series at a time 726, and manually start recording at this time 728. The user may also activate a query search of the programming guide for content to record via the search icon 730 from this screen.

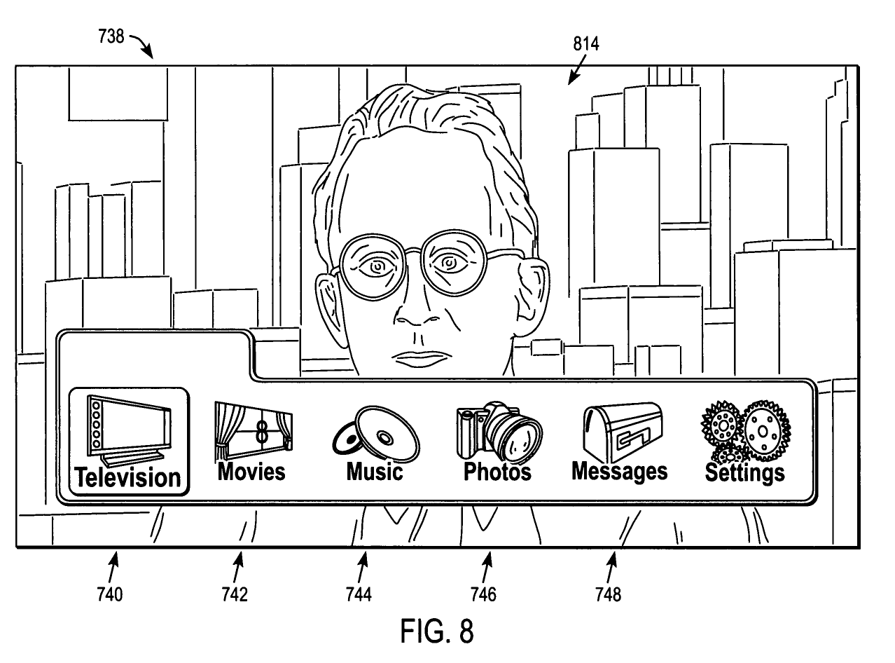

FIG. 8 illustrates another embodiment of a screen shot of the main page of the user interface. The user may access satellite content via the Television icon 740 on the main page 738. The user may access Video-on-Demand movies or movies in the local DVD player via the Movies icon 742. The user may access music content stored on a networked device, on the local hard drive, on the local CD-ROM/DVD player, or on the Internet icon via the Music icon 744. The user may access photographs and photograph albums stored on a networked device, on the local hard drive, on the local port connectable to a Digital Camera, or on the Internet icon via the Photo icon 746. The user may access messaging services such as e-mail, instant messages, text messages, and phone voice mail messages via activation of the Messages icon 748. The user interface also contains code scripted to continue to display video stream, such as a TV program or movie, in a picture window 814 while the user browses and progresses through selections on the user interface.

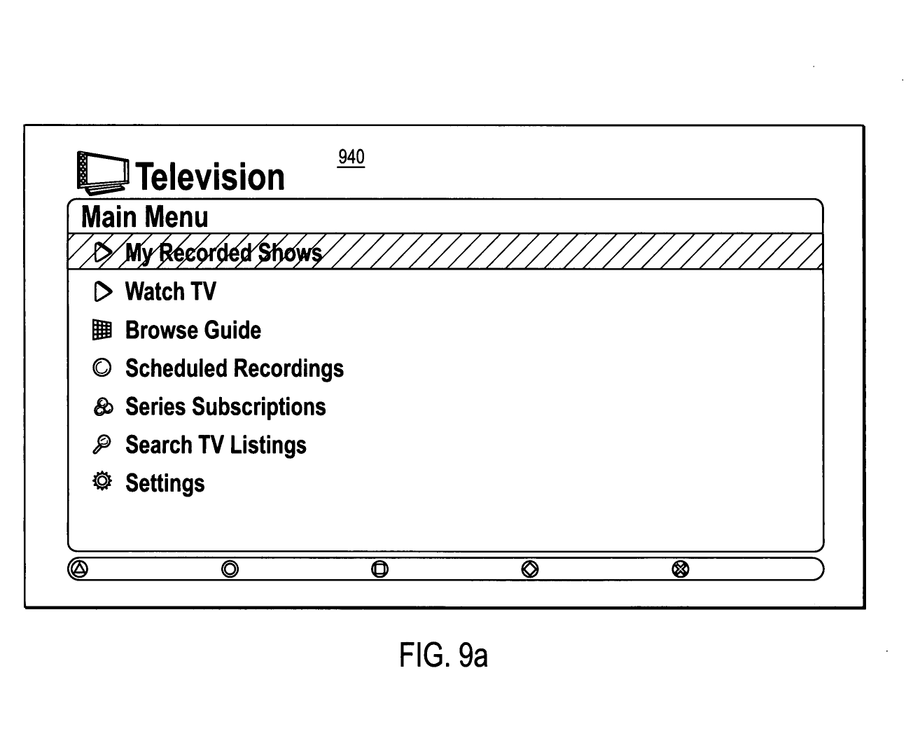

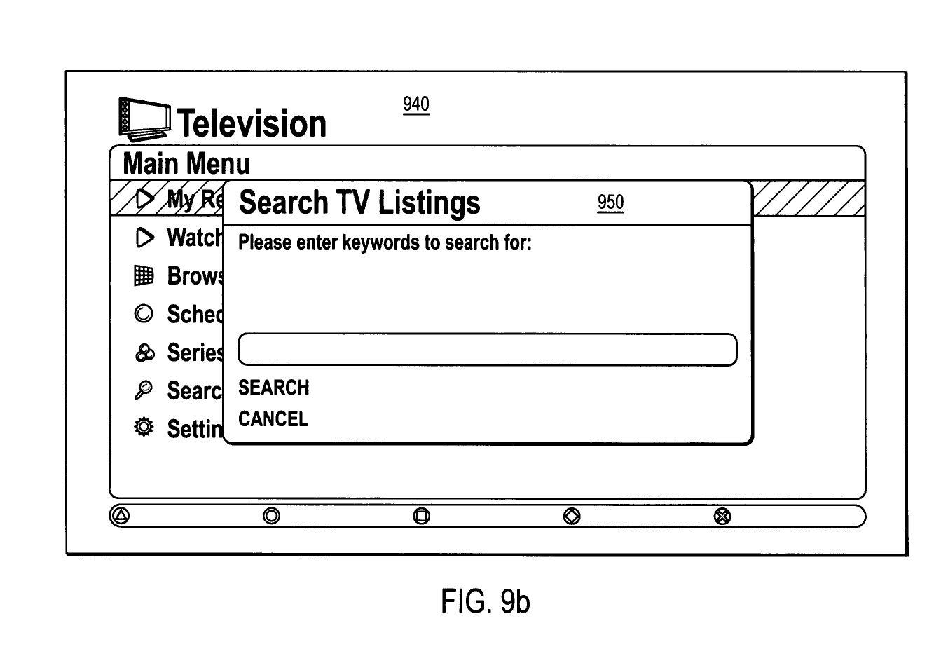

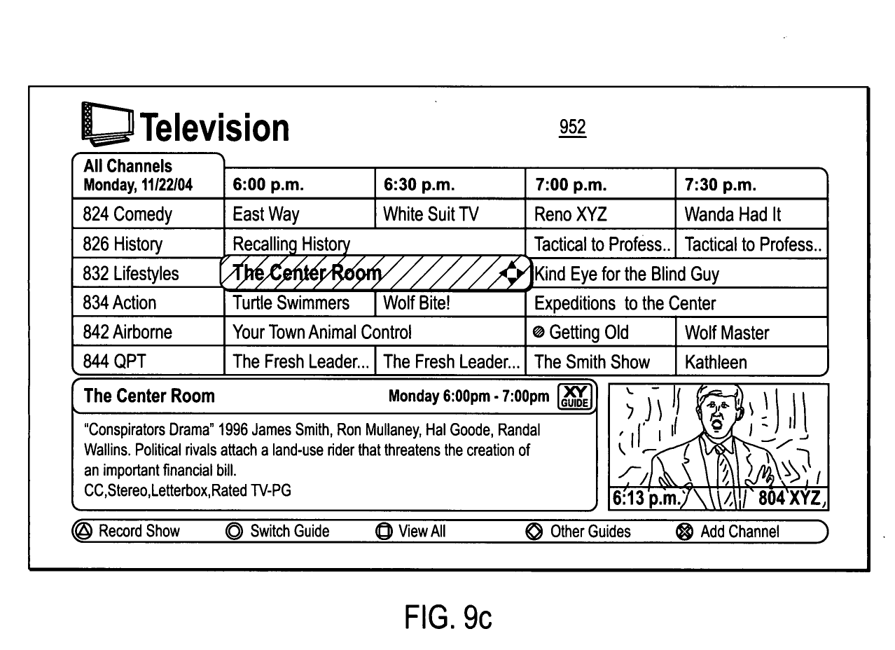

FIG. 9a illustrates an embodiment of a screen shot of the Television Menu screen of the user interface. The Television Menu screen 940 allows a user watch a program from the satellite video stream, access the digital video recorder to watch recorded shows, browse the electronic programming guide, schedule recordings, etc. FIG. 9b illustrates an embodiment of a screen shot of the Search function 950 for the Television Menu screen 940 of the user interface. A user may enter key words to query for all programs in the programming guide that match those key terms. The user may refine the search by fields such as program title or category. FIG. 9c illustrates an embodiment of a screen shot of the electronic program guide 952 for the Television Menu screen of the user interface.

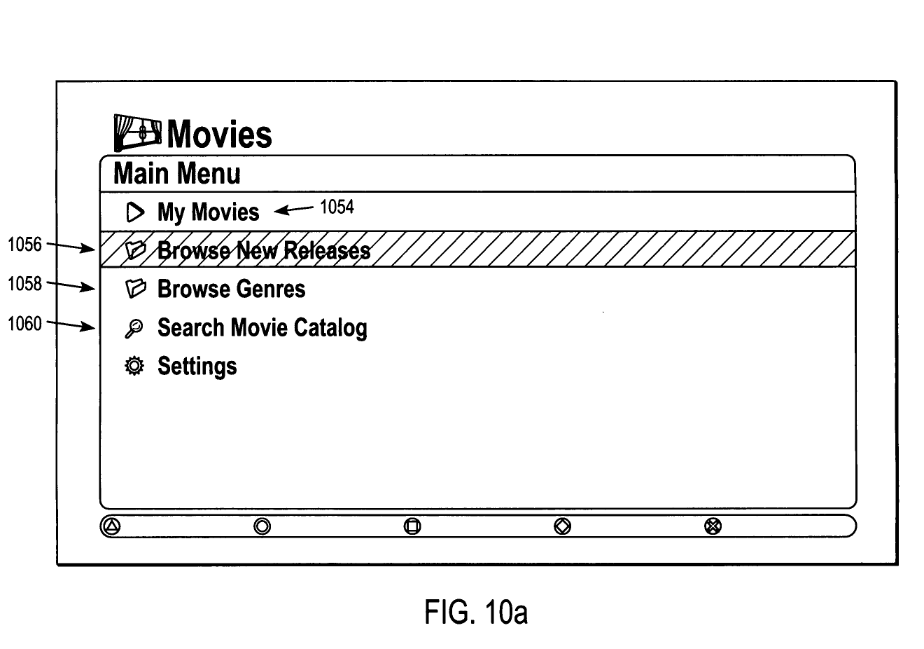

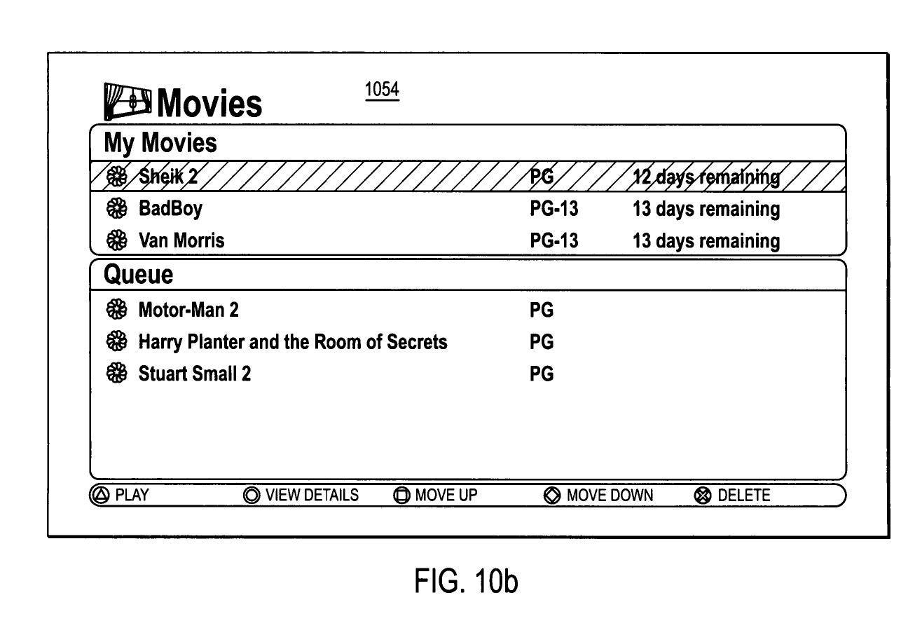

FIG. 10a illustrates an embodiment of a screen shot of the Movies main menu of the user interface. The user may view a selection of downloaded movies via the My Movies icon 1054 as shown in FIG. 10b. The user may browse a selection of newly released Movies-on-Demand via the New Release icon 1056. The user may browse a selection of Movies-on-Demand by genres via the Genres icon 1058. The user may also browse the entire catalog of available Movies-on-Demand via the Movie Catalog icon 1060.

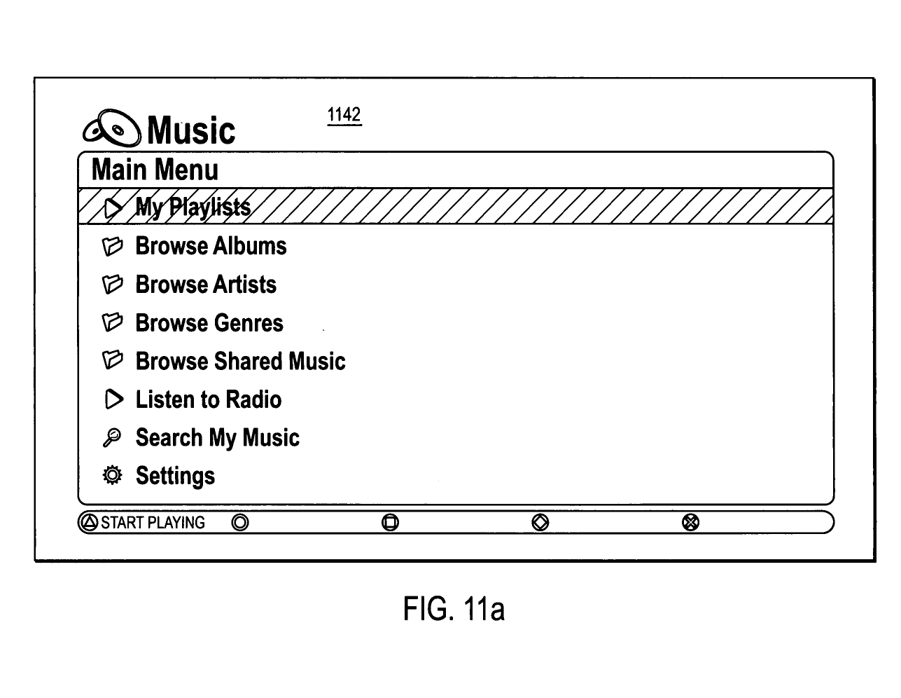

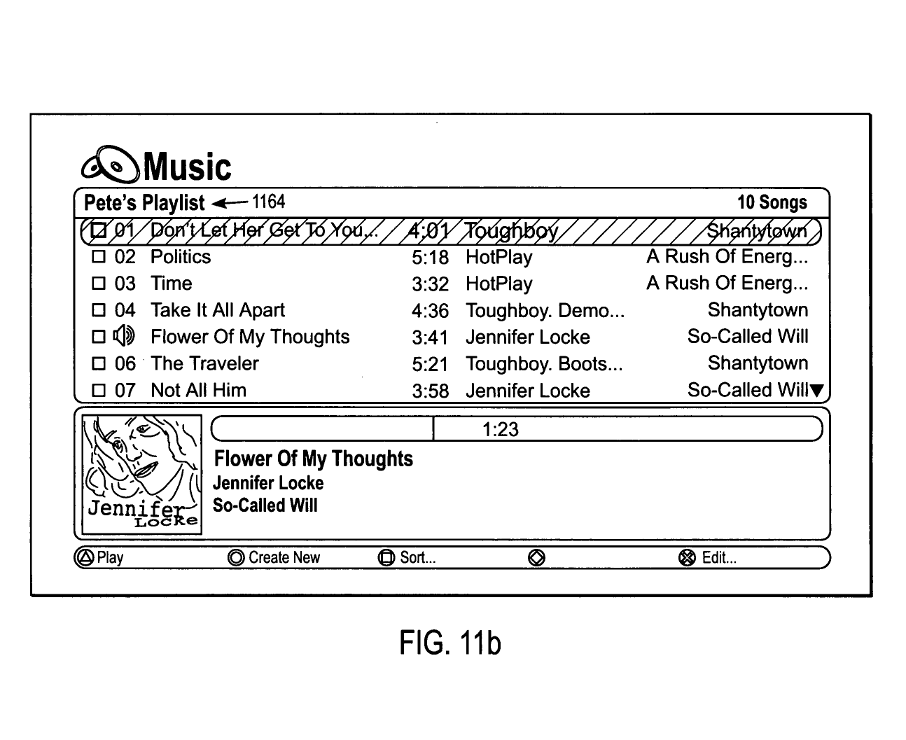

FIG. 11a illustrates an embodiment of a screen shot of the Music main menu of the user interface. The user may select songs by different categories and different sources as indicated in the Music main menu screen 1142. The user may select songs stored on the hard disk from a playlist 1164 as illustrated in FIG. 11b. The user may also select may select songs to listen to organized by category, etc by activating the appropriate icon.

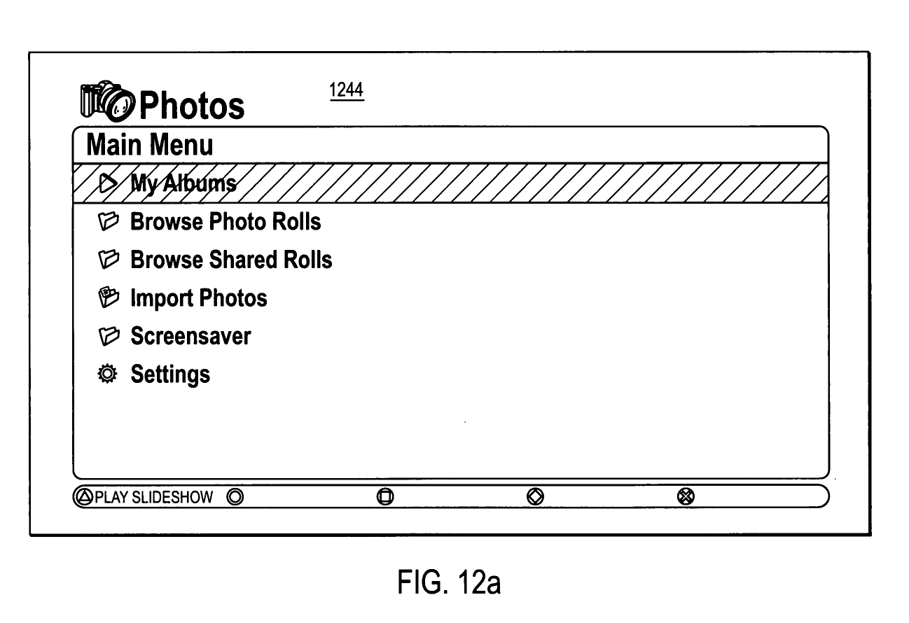

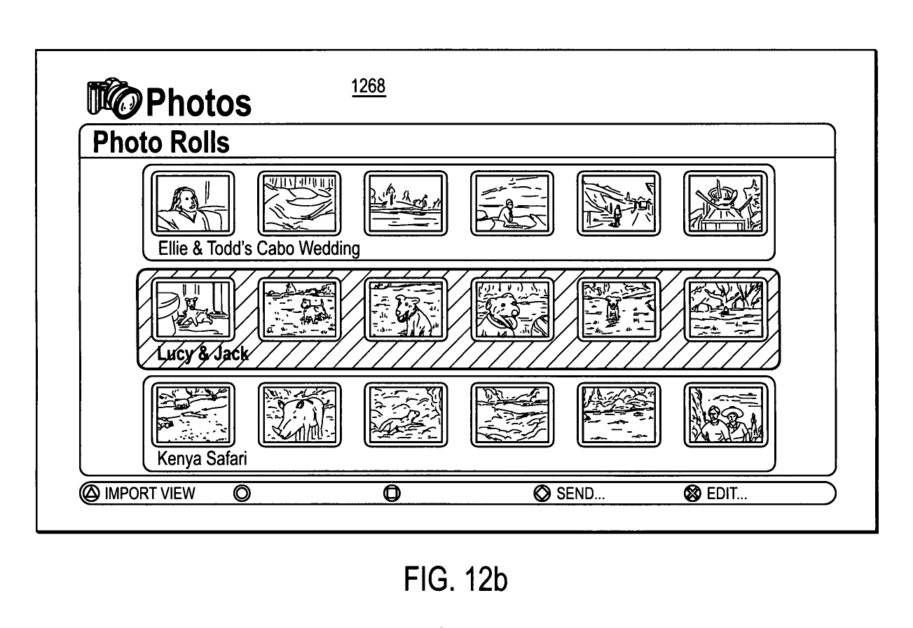

FIG. 12a illustrates an embodiment of a screen shot of the Photos main menu of the user interface. The user may view digital photographs, import digital photographs, set photographs as screensavers, etc with the icons on the Photos main menu 1244 of the user interface. The user may select photographs, potentially organized by albums, to view from a list in the photo rolls page 1268 as illustrated in FIG. 12b. The user is allowed to manipulate these photographs via buttons such as import view, send, edit, etc. that are in this photo rolls page 1268.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

For example, the central management system 102 also facilitates purchases between or e-commerce providers 104 and the set top box 224.

Also, a machine-readable medium may be provided having one or more instructions stored thereon, which instructions may be used to program a computer system or other electronic device to perform the operations described. A machine-readable medium may include any mechanism for storing or transmitting information in a form (e.g., software or processing application) readable by a machine (e.g., a computer). The machine-readable medium may include, but is not limited to, magnetic storage media (e.g., a floppy diskette), optical storage media (e.g., CD-ROM, CD-RW, DVD, etc.), magneto-optical storage media, read only memory (ROM), random access memory (RAM), erasable programmable memory (e.g., EPROM and EEPROM), flash memory, electrical, optical, acoustical, or other forms of propagated signal (e.g. carrier waves, infrared signals, digital signals, etc.), or other types of media suitable for storing electronic instructions.

While some specific embodiments of the invention have been shown the invention is not to be limited to these embodiments. The invention is to be understood as not limited by the specific embodiments described herein, but only by scope of the appended claims.

What is claimed is:

1. A set top box, comprising:
a satellite television receiver module to receive satellite television broadcasts and convert the broadcast for display on a television;
a broadband Internet module to convert content in a broadband signal for display on the television;
a digital video recorder (DVR) to allow a user to manipulate a digital stream of video programming from the satellite television broadcast including a capability to pause a display of live broadcast feeds;
a storage medium to store digital photograph files as well as the television programs from the satellite television broadcast within the set top box;
a first output port to couple to a first network that carries digital signals from the set top box; and
an integrated user interface displayed on the television to allow a user to access an integrated content user experience by displaying icons that allow the user to select content from the satellite television broadcasts, the content in the broadband signal, and content from a first computer connected to the first network that carries digital signals.

2. The set top box of claim 1, further comprising:
a central management system interface to communicate with a remote central management system, wherein the central management system administers and integrates a billing exchange between a content provider, the central management system, and a user's service provider.

3. The set top box of claim 1, wherein the central management system interface provides a voucher token to the content provider to allow the set top box to download selected content from the content provider.

4. The set top box of claim 1, wherein a central management system performs catalog aggregation to present a common catalog presentation on the user interface of available content based on a type of content independent of the source of the content.

5. The set top box of claim 1, further comprising:
a network module running on a set top box and that contains code scripted to access the first computer to obtain the digital photograph files as well as digital music files.

6. The set top box of claim 1, wherein the integrated user interface contains code scripted to access the storage medium to obtain the digital photograph files as well as digital music files, wherein the integrated user interface contains code scripted to allow a user to browse and manage the digital photograph files and the digital music files from the set top box.

7. The set top box of claim 1, further comprising:
a network module containing code scripted to allow a user to select a first digital music file to listen to from a first browser-enabled device located in room other than the room containing the set top box.

8. The set top box of claim 1, further comprising:
a second output port to couple to a second network that carries analog video signals from the set top box.

9. The set top box of claim 1, further comprising:
a photo application containing code scripted to automatically detect a digital camera device connecting to the set top box, wherein the photo application loads a software driver for the digital camera device and automatically downloads any digital photograph files stored in the digital camera device into the storage medium.

10. The set top box of claim 1, wherein the DVR includes a personal video recorder module to allow a user to further manipulate the digital stream of video programming by performing any one of the following operations selected from the group consisting of 1) fast forwarding through frames of the digital stream of video programming, 2) reversing through frames of the digital stream, 3) skipping back a preset amount of time in the digital stream, and 4) skipping forward a preset amount of time in the digital stream.

11. The set top box of claim 2, further comprising:
a web enabled remote access module to establish a secure link between a browser enabled device connected to the Internet and the set top box via the central management system.

12. The set top box of claim 1, wherein the broadband Internet module includes a module configured to run Video on Demand content from a content provider on the Internet and to display the Video on Demand on the television.

13. The set top box of claim 1, wherein the integrated user interface contains code scripted to present digital photograph files stored on the first computer for display on the television.

14. The set top box of claim 1, further comprising:
a remote stream play control block associated with the DVR in the set top box;
a remote unit to receive the digital stream of video from the set top box and couples to the first network, wherein the remote stream play control block compresses the digital stream of video for transport over the first network that carries digital signals by sending a subset of video frames of the total number of video frames making up the digital stream of video during a fast forward or a reverse operation.

15. The set top box of claim 1, wherein the integrated user interface contains code scripted to present e-mail messages and instant messages on the television that overlays text associated with the e-mail message or instant message over a current program being displayed on the television.

16. The set top box of claim 1, wherein the integrated user interface contains code scripted to present caller ID information and call-log information that overlays text associated with the caller ID information or call-log information over a current program being displayed on the television.

17. The set top box of claim 1, wherein the integrated user interface contains code scripted to broadcast a message from a phone service voice mail through the television.

18. The set top box of claim 1, further comprising:
a second output port to couple to the first network that carries audio signals from the set top box.

19. The set top box of claim 2, further comprising:
a web enabled remote access module containing code scripted to integrate with a third party web site to retrieve multi-media content from that website via application program interfaces and a security mechanism that uses a shared secret between the set top box and the third party website, wherein the web enabled remote access module cooperates with the television receiver module to properly display that content on the television.

20. A system, comprising:
a set top box that includes
a satellite television receiver module to receive satellite television
broadcasts and to convert the broadcast for display on a television;
a broadband Internet module to convert content in a
broadband signal for display on the television;
a digital video recorder (DVR) to allow a user to manipulate
a digital stream of video programming from the satellite television broadcast including a pausing of live broadcast feeds;
a storage medium to store digital multimedia files as well as the television programs from the satellite television broadcast within the set top box;
a central management system interface to communicate with a remote central management system, wherein the central management system administers and integrates a billing exchange between a content provider, the central management system, and a service provider; and
an integrated user interface displayed on the television to allow a user to access an integrated content user experience by displaying icons that allow the user to select content from the satellite television broadcasts, and the multimedia content from the broadband signal.

21. The system of claim 20, wherein the central management system transmits a voucher token to the central management system interface, and the central management system interface transmits the voucher token to the content provider to allow the set top box to download selected content from the content provider.

22. The system of claim 20, further comprising:
a remote stream play control block associated with the DVR in the set top box; and
a remote unit to receive the digital stream of video from the set top box, wherein the remote stream play control block compresses the digital stream of video for transport over a local area network that carries digital signals by sending a subset of video frames of the total number of video frames making up the stream of video during a fast forward or a reverse operation.

23. The system of claim 20, wherein the set top box further includes
a first output port to couple to a first network that carries analog video signals from the set top box; and
a second output port to couple to a second network that carries digital signals from the set top box.

24. A set top box to output two or more independent multi-media data streams, comprising:
a broadcast television application to supply a first program data stream of content to a first television coupled to the set top box, and to supply a second program data stream of content to a second television coupled to the set top box, wherein the content of the first program data stream is independent of the content in the second program data stream and the first program data stream and the second program data stream are supplied at the same time;
a network application to send and retrieve multi-media data for the broadcast television application from a first computing device external to the set top box; and
a digital video recorder (DVR) to allow a user to manipulate the first program data stream and the second program data stream from the broadcast television application.

25. The set top box of claim 24, further comprising:
a remote access application cooperating with a xDSL gateway, wherein the remote access application contains code scripted to send and retrieve over a Wide Area network scheduling information for the digital video recorder from a second computing device connected to the Wide Area Network that the set top box is part of.

26. The set top box of claim 24, wherein the computing device is a cellular phone, a lap top computer, or other wireless portable computing device.

27. The set top box of claim 25, further comprising:
a broadcast satellite interface to retrieve the first program data stream of content from a satellite broadcast.

28. The set top box of claim 25, further comprising:
a movie application containing code scripted to allow a user to select a first digital movie file to watch from the second television located in room other than the room containing the top box.

29. The set top box of claim 24, further comprising:
a movie application to run resident on an operating system software of the set top box and to a first digital movie file to the first television at the same time the broadcast television application supplies the second program data stream of content to the second television.
